(19) United States
(12) Patent Application Publication
(10) Pub. No.: US 2007/0070912 A1
(43) Pub. Date: Mar. 29, 2007

(54) Method for notifying at least one application of changes of state in network resources, a computer program and a change-of-state notification system for implementing the method

(76) Inventors: Yvon Gourhant, Lannion (FR); Djamal-Eddine Meddour, Lannion (FR); Bertrand Mathieu, Lannion (FR)

Correspondence Address: OLIFF & BERRIDGE, PLC, P.O. BOX 19928, ALEXANDRIA, VA, 22320, US

(21) Appl. No.: 10/578,101

(22) PCT Filed: Oct. 29, 2004
(86) PCT No.: PCT/FR04/02798

§ 371 Date: Aug. 10, 2006

(30) Foreign Application Priority Data
Nov. 3, 2003 (FR) 0312869

(51) Int. Cl. H04J 3/14; H04J 1/16; H04Q 7/24

(52) U.S. Cl. 370/252; 370/238; 370/338

(57) ABSTRACT

This method for notifying changes of state in the resources of a network to at least one application adapted to execute on the network, comprises the following steps: extracting routing information, using change-of-state notification means with which the application has previously been register; and forwarding said routing information extracted by the notification means to the application.

The present invention relates to a method for notifying at least one application adapted to be executed on a network of changes of state in the resources of said network. The invention also relates to a computer program and a change-of-state notification system a for implementing the method.

This type of method is generally implemented for applications that are sensitive to changes of state in the network on which they are executing. Such software applications generally perform services that are vital to the network, including discovering network resources (JINI®, UpnP®, Salutation®, SLP applications), managing quality of service, or indeed managing groups (HORUS® system).

The changes of state in the network that may be of interest to such applications include, for example, the disappearance and/or the reappearance of a node of the network, the movement of a node within the network, and quality-of-service information such as changes in the capacities of the links and nodes in use (passband, computation capacity, batteries, etc.).

A method of the above-specified type is already known in the prior art. With the JINI® application, a services directory known as a “Lookup Server” keeps up to date a list of applications servers available on the network, with the help of a refresh method (commonly referred to as a “leasing” mechanism). In that refresh method, the applications servers must periodically renew their subscriptions to the services directory by informing it that they are still in operation, otherwise they are automatically removed from the list.

That solution operates correctly in a conventional wired network in which the nodes, the links, and the applications servers are relatively stable, but it is much less well adapted to an ad-hoc network, i.e. a network that does not have any predetermined infrastructure, and in which the available passband is also limited, with nodes that are potentially mobile, possibly serving simultaneously to execute applications and possessing characteristics that are varied in terms of battery life, execution capacities, and passband.

In networks of that type without infrastructure, if it is desired to apply that refresh mechanism for proper operation of the JINI® services directory application, the parameter specifying the time interval between two refreshes must be set to a value that is small enough to compensate for the incessant modifications in the structure of the network. However, the shorter this time interval, the greater the passband that is taken up for conveying this information in the ad-hoc network, which raises problems in a network where the passband resource is limited.

Similarly, for applications of the “group management” type, information needs to be exchanged regularly through the ad-hoc network between the nodes of the network in order to keep up-to-date information about the group being managed by the application. This information likewise generates an additional data stream through the ad-hoc network in which passband is limited.

For applications that are sensitive to quality of service, such as multimedia applications, information about the capacities of the links and the nodes being used need to be exchanged between the nodes in order to identify and monitor paths that comply with the quality-of-service conditions required by the applications. Changes of state can arise if a node is mobile, if a node is being used in a manner other than for transmitting data to other nodes, or indeed if a node switches to an energy-saving mode. Such changes can have an impact on the quality of service negotiated with applications, so it is preferable for applications to be notified of such changes before they detect the changes themselves, in order to avoid degrading quality of service or interrupting the service.

The invention remedy those drawbacks by providing a method for notifying changes of state that is capable of providing applications that are adapted to execute on a network with information about the changes of state in the network, while restricting as much as possible the extra cost due to transmitting said information over the network. The invention thus seeks to provide a notification method that is particularly adapted to ad-hoc type networks.

The invention thus provides a method for notifying changes of state in the resources of a network to at least one application adapted to execute on the network, the method being characterized in that it comprises the following steps:

extracting routing information, using change-of-state notification means with which the application has previously been registered; and

forwarding said routing information extracted by the notification means to the application.

The routing protocols implemented in any network, and in particular in ad-hoc networks, generate traffic enabling the state of the network to be known and enabling information relating to said state to be updated. This information can relate to a change in passband due to radio interference between a plurality of co-located nodes, or a change in the routing capacities of a node that is in use, due to said node being used to perform applications processing, or to use of the node being economized in order to reduce its energy consumption when it is running on a battery.

The invention thus makes it possible to use this routing information for transmission to applications that are adapted to execute on the network without it being necessary for the applications themselves to verify the states of the nodes in the network with which they communicate while they are being executed. Thus, for applications such as a services directory or an application for discovering services (JINI®), conventional refresh mechanisms can be replaced by forwarding at least a portion of the routing information to the applications concerned. Similarly, for an application of the group management type, the network routing information can provide information about the state of the group and can thus be forwarded without extra cost through the network and with simplification in the applications adapted to execute on the network.

In addition, for a multimedia application, the change of network state information that is forwarded to the application enables it to adapt thereto, e.g. for the purpose of redefining a quality-of-service contract.

The information thus serves to extract information that is usually exchanged at levels of the network that are used for routing the information being conveyed, for the purpose of forwarding that information to higher levels in which execution of the applications themselves is managed.

A change-of-state notification method of the invention may also include one or more of the following characteristics:

during the prior registration step, a fraction of the nodes and/or of the links of the network is selected so that the information that is extracted and forwarded to said application is routing information relating to said selected fraction of the nodes and/or of the links;

the network is an ad-hoc network, and the routing information is extracted by interrogating a routing protocol implemented in the ad-hoc network;

the routing information is extracted from routing tables exchanged by a proactive routing protocol of the ad-hoc network, in particular the OLSR protocol; and

the method further includes a step of dynamically extending the notification means during which new extraction rules are introduced into the notification means corresponding to new routing information that has been deployed on the network.

An advantage of the OLSR protocol is that it does indeed enable the notification means to be dynamically extended in this way. In a proactive network, a packet that is exchanged between two routers can convey not only data but also programs. By way of example, the method can be implemented using the JAVA® code downloading technology known as OSGi®.

The invention also provides a computer program for notifying changes of state in the resources of a network to at least one application adapted to execute on the network, the program being characterized in that for an application that has previously been registered with the program, it includes means for extracting routing information, and means for forwarding the extracted information to the application.

Finally, the invention also provides a system for notifying changes of state in the resources of a network, the system comprising the network and at least one application adapted to execute on the network, and being characterized in that it includes a computer program as described above, and installed on at least one of the nodes of the network.

The invention can be better understood from the following description given purely by way of example and made with reference to the accompanying drawing, in which:

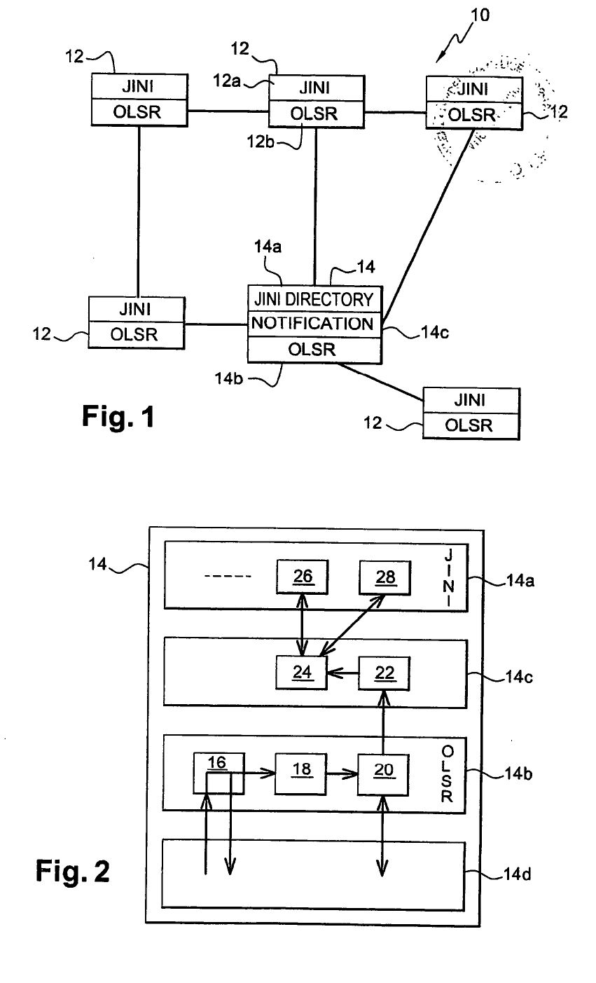

FIG. 1 is a diagram of the structure of an installation in accordance with the invention; and

FIG. 2 shows the functional elements of a server implementing the method of the invention.

The installation shown in FIG. 1 comprise an ad-hoc network 10 constituted by nodes 12, 14 and by links between some of the nodes.

An ad-hoc network is made up of nodes that are mobile or stationary, having the property of automatically and dynamically building up a network that is capable of conveying packets from any point of the network to any other point, providing radio communication is established between each node and its neighbors.

Each node 12, 14 is an electronic device capable of communicating a priori with the other nodes of the network, either because they are connected thereto directly, or else indirectly (e.g. by a series of neighbor-to-neighbor connections). For example, the nodes of an ad-hoc network can be constituted by devices such as a personal digital assistant (PDA), a mobile telephone, a wireless microcomputer, etc.

In order to be capable of forming part of the ad-hoc network 10, each device 12, 14 is provided with routing applications complying with a common protocol 12b, 14b of the network or transport layer in the OSI system, for routing data in the ad-hoc network. By way of example, this protocol is the proactive OLSR protocol which is adapted to exchange routing tables periodically between the nodes of the network. Thus, each node of the ad-hoc network also acts as a router for transmitting information from one point of the network to another.

In addition, each of the nodes 12, 14 of the ad-hoc network 10 may optionally include applications in compliance with a protocol 12a, 14a of the applications layer in the OSI system, e.g. using JINI® technology.

In order to share these applications, the ad-hoc network 10 includes a special node 14 that acts as a server for managing applications. For this purpose, the server 14 comprises not only routing applications in compliance with the common protocol 14b of the network or transport layer and applications in compliance with the protocol 14a of the applications layer, but also notification means 14c that are intermediate between said applications. The function of the notification means 14c is to extract routing information exchanged by the routing applications (e.g. OLSR routing tables) in order to forward that information to previously-registered JINI® applications. These means thus notify the applications concerned of changes of state in the resources of the ad-hoc network.

As shown in FIG. 2, the server 14 for managing applications includes applications in compliance with the common protocol 14d of the physical layer for exchanging data between said server and the other nodes of the ad-hoc network 10.

The routing functions in compliance with the protocol 14b of the applications server 14 include event filter means 16 for filtering events coming from the layer 14d so as to forward a fraction of these events, in particular those that relate to routing, to analysis means 18. These events are processed by the analysis means 18 so that said means forward them in the form of change-of-state topology information to means 20 for updating the topology of the ad-hoc network 10. The ways in which the filter means 16, the analysis means 18, and the updater means 20 operate and interact are conventional. They are therefore not described in detail.

The means 20 for updating the topology of the ad-hoc network 10 can also extract a fraction of events directly from the layer 14d. They serve to provide routing tables that are subsequently regularly interchanged between the nodes of the ad-hoc network.

The notification means 14c are implemented as intermediaries between the routing applications of the layer 14b and the JINI® applications of the layer 14a. These notification means 14c include first means 22 for extracting routing information from the means 20 for updating the topology of the network. In particular, the routing information is extracted directly from the OLSR routing tables when OLSR routing is implemented.

The OLSR protocol also enables the notification means 14c to be extended dynamically by introducing new extraction rules in the notification means corresponding to new routing information being deployed on the network 10.

The information extracted by the means 22 is subsequently forwarded to means 24 for forwarding said information to various applications that have previously been registered with the notification means 14c.

By way of example, These applications include a services directory 26 of the “Lookup Server” type, or other applications implemented using JINI® technology.

These applications may also include a group management application 28.

During a prior step, each of the JINI® applications of the layer 14a concerned with receiving event notifications, registers with the transmission means 24 to indicate the type of information that is of interest thereto, i.e. in particular information relating to the nodes of the network that might have an influence on implementing the application in question.

This information extracted by the extractor means 22 is obtained either directly from the routing tables as mentioned above, when proactive protocols such as the OLSR protocol are implemented, or with the help of specific interfaces created for interrogating the routing protocols implemented by the ad-hoc network, in particular when using reactive routing protocols, for example.

It can clearly be seen that a method and a system for notifying events as described above make it possible to inform the various applications implemented in the ad-hoc network in real time about which nodes of the ad-hoc network are available or not available, and to do this without overloading passband, since use is made solely of routing information that is in any event continuously being conveyed through the ad-hoc network.

Finally, it should be observed that the application is not limited to the embodiment described above.

In particular, in a variant the applications suitable for being notified by means of the method may comply with technologies other than the JINI® technology.

1. A method of notifying changes of state in the resources of a network to at least one application adapted to execute on the network, the method comprising the following steps:
extracting routing information, using change-of-state notification means with which the application has previously been registered; and
forwarding said routing information extracted by the notification means to the application.

2. A change-of-state notification method according to claim 1, wherein, during the prior registration step, a fraction of the nodes and/or of the links of the network is selected so that the information that is extracted and forwarded to said application is routing information relating to said selected fraction of the nodes and/or of the links.

3. A change-of-state notification method according to claim 1, wherein the network is an ad-hoc network, and in that the routing information is extracted by interrogating a routing protocol implemented in the ad-hoc network.

4. A change-of-state notification method according to claim 3, wherein the routing information is extracted from routing tables exchanged by a proactive routing protocol of the ad-hoc network, in particular the OLSR protocol.

5. A change-of-state notification method according to claim 1, further including a step of dynamically extending the notification means during which new extraction rules are introduced into the notification means corresponding to new routing information that has been deployed on the network.

6. A computer program for notifying changes of state in the resources of a network to at least one application adapted to execute on the network, the program including, for an application that has previously been registered with the program, means for extracting routing information, and means for forwarding the extracted information to the application.

7. A system for notifying changes of state in the resources of a network, the system comprising the network and at least one application adapted to execute on the network, and including a computer program installed on at least one of the nodes of the network, the program including, for an application that has previously been registered with the program, means for extracting routing information, and means for forwarding the extracted information to the application.

8. Node of a network, comprising routing applications, wherein it comprises further a computer program including, for an application that has previously been registered with the program, means for extracting routing information, and means for forwarding the extracted information to the application.
